(19) United States
(12) Patent Application Publication
(10) Pub. No.: US 2019/0128198 A1
(43) Pub. Date: May 2, 2019

(54) CONTROLLER AND CONTROL METHOD FOR INTERNAL COMBUSTION ENGINE

(71) Applicant: TOYOTA JIDOSHA KABUSHIKI KAISHA, Toyota-shi (JP)

(72) Inventors: Misako BAN, Toyota-shi (JP); Keiichi MYOJO, Okazaki-shi (JP); Yoshiyuki SHOGENJI, Toyota-shi (JP); Yuki NOSE, Kasugai-shi (JP); Eiji IKUTA, Oobu-shi (JP)

(73) Assignee: TOYOTA JIDOSHA KABUSHIKI KAISHA, Toyota-shi (JP)

(21) Appl. No.: 16/161,734

(22) Filed: Oct. 16, 2018

(30) Foreign Application Priority Data
Oct. 26, 2017 (JP) 2017-207372

(51) Int. Cl. F02D 41/14; F01N 3/10; F02D 41/00; F02D 41/02; F01N 11/00

(52) U.S. Cl. CPC F02D 41/1408; F01N 3/101; F02D 41/008; F01N 2550/02; F01N 11/007; F02D 41/1456; F01N 2430/06; F02D 41/0295

(57) ABSTRACT

A CPU operates a purge valve to control the amount of fuel vapor that flows into an intake passage from a canister. If there is a requirement for increasing the temperature of a three-way catalyst, the CPU executes dither control in which the air-fuel ratio of one of cylinders #1 to #4 is made richer than the stoichiometric air-fuel ratio, and the air-fuel ratio of the remaining cylinders is made leaner than the stoichiometric air-fuel ratio. The CPU executes the dither control and performs feedforward correction of the distribution variation of the fuel vapor to the cylinders #1 to #4 if the amount of fuel vapor from the canister to the intake passage is greater than zero.

### BACKGROUND

The present disclosure relates to a controller and control method for an internal combustion engine.

For example, the controller disclosed in Japanese Laid-Open Patent Publication No. 2012-57492 executes perturbation control (dither control). In the perturbation control, when there is a requirement for warm-up of a catalyst device (catalyst), the air-fuel ratio is made richer than the stoichiometric air-fuel ratio in some cylinders, while the air-fuel ratio is made leaner than the stoichiometric air-fuel ratio in the other cylinders. Also, purge control has been known, in which fuel vapor in the fuel tank, which stores fuel to be injected from the fuel injection valves, is returned to the intake passage.

The dither control is executed in such a manner that the air-fuel ratio in the rich combustion cylinders differs from the air-fuel ratio in the lean combustion cylinders. This causes limits to the setting of the air-fuel ratios for inhibiting deterioration of combustion as compared with a case in which the air-fuel ratios of all the cylinders are controlled to be the same. That is, the combustion easily deteriorates when the dither control is executed. If the purge control is executed, the fuel vapor is not necessarily distributed equally to the cylinders. This causes the air-fuel ratios in the cylinders to differ from each other. Thus, if the dither control is executed together with the purge control, the deterioration of the combustion caused by the dither control is promoted by the variation in the distribution of the fuel vapor among the cylinders during the purge control.

### SUMMARY

In accordance with a first aspect of the present disclosure, the following examples are provided.

### EXAMPLE 1

A controller for an internal combustion engine is provided, in which the internal combustion engine includes an exhaust purifying device, which purifies exhaust gas discharged from a plurality of cylinders, fuel injection valves provided for the respective cylinders, a canister, which collects fuel vapor in a fuel tank, which stores fuel to be injected by the fuel injection valves, and an adjustment device, which adjusts a flow rate of fluid from the canister to an intake passage. The controller is configured to execute: a dither control process of operating the fuel injection valves in such a manner that at least one of the cylinders is designated as a lean combustion cylinder, in which an air-fuel ratio is leaner than a stoichiometric air-fuel ratio, and at least another one of the cylinders is designated as a rich combustion cylinder, in which an air-fuel ratio is richer than a stoichiometric air-fuel ratio; a purge control process of operating the adjustment device in such a manner to control the flow rate of the fluid from the canister to the intake passage; and a respective-cylinder correction process of correcting, on condition that the flow rate of the fluid is controlled to a value greater than zero by the purge control process, the amount of fuel to be injected from the fuel injection valve by the dither control process for each of the cylinders to compensate for variation in distribution of the fuel vapor that flows into the intake passage from the canister among the cylinders.

### EXAMPLE 2

In the above-described controller for an internal combustion engine, the respective-cylinder correction process is a process of calculating a correction amount of each of the cylinders in accordance with a rotation speed and a load of a crankshaft of the internal combustion engine.

### EXAMPLE 3

In the above-described controller for an internal combustion engine, the controller is configured to execute: a base injection amount calculating process of calculating a base injection amount in accordance with an air amount filling a combustion chamber of the internal combustion engine; a reduction correction amount calculating process of calculating a reduction correction amount for correcting the base injection amount to be reduced in accordance with the flow rate of the fluid; and a required injection amount calculating process of calculating a required injection amount in accordance with the process of correcting the base injection amount to be reduced using the reduction correction amount. The dither control process is a process of determining the injection amount of the fuel injection valve that injects fuel to the lean combustion cylinder by correcting the required injection amount to be reduced and determining the injection amount of the fuel injection valve that injects fuel to the rich combustion cylinder by correcting the required injection amount to be increased. The respective-cylinder correction process is a process of correcting the required injection amount used by the dither control process for each of the cylinders and calculating the correction amount for each of the cylinders in accordance with the reduction correction amount.

### EXAMPLE 4

In the above-described controller for an internal combustion engine, the respective-cylinder correction process corrects the amount of fuel to be injected from the fuel injection valve by the dither control process executed in response to a warm-up requirement for warming up the exhaust purifying device.

### EXAMPLE 5

In the above-described controller for an internal combustion engine, the dither control process executed in response to the warm-up requirement is executed when an actual operating point is in a first set of operating points determined in accordance with the rotation speed and the load of the crankshaft of the internal combustion engine and is not executed when the actual operating point is in a second set, which does not include the operating points of the first set. The respective-cylinder correction process is not executed when the actual operating point is in the second set.

### EXAMPLE 6

In the above-described controller for an internal combustion engine, the respective-cylinder correction process is executed on condition that the amount of the fuel vapor that flows into the intake passage from the canister by the purge control process is greater than or equal to a specified amount.

### EXAMPLE 7

In the above-described controller for an internal combustion engine, the controller is configured to execute, if an absolute value of a difference between the air-fuel ratio of the lean combustion cylinder and the air-fuel ratio of the rich combustion cylinder caused by the dither control process is greater than or equal to a predetermined value, a limiting process of limiting the flow rate of the fluid by the purge control process to be smaller than that in a case in which the absolute value is less than the predetermined value.

In accordance with a second aspect of the present disclosure, a controller for an internal combustion engine is provided. The internal combustion engine includes an exhaust purifying device, which purifies exhaust gas discharged from a plurality of cylinders, fuel injection valves provided for the respective the cylinders, a canister, which collects fuel vapor in a fuel tank, which stores fuel to be injected by the fuel injection valves, and an adjustment device, which adjusts a flow rate of fluid from the canister to an intake passage. The controller comprises circuitry configured to execute: a dither control process of operating the fuel injection valves in such a manner that at least one of the cylinders is designated as a lean combustion cylinder, in which an air-fuel ratio is leaner than a stoichiometric air-fuel ratio, and at least another one of the cylinders is designated as a rich combustion cylinder, in which an air-fuel ratio is richer than a stoichiometric air-fuel ratio; a purge control process of operating the adjustment device in such a manner to control the flow rate of the fluid from the canister to the intake passage; and a respective-cylinder correction process of correcting, on condition that the flow rate of the fluid is controlled to a value greater than zero by the purge control process, the amount of fuel to be injected from the fuel injection valve by the dither control process for each of the cylinders to compensate for variation in distribution of the fuel vapor that flows into the intake passage from the canister among the cylinders.

In accordance with a third aspect of the present disclosure, a method for controlling an internal combustion engine is provided. The internal combustion engine includes an exhaust purifying device, which purifies exhaust gas discharged from a plurality of cylinders, fuel injection valves provided for the respective cylinders, a canister, which collects fuel vapor in a fuel tank, which stores fuel to be injected by the fuel injection valves, and an adjustment device, which adjusts a flow rate of fluid from the canister to an intake passage. The control method includes: operating the fuel injection valves through a dither control process in such a manner that at least one of the cylinders is designated as a lean combustion cylinder, in which an air-fuel ratio is leaner than a stoichiometric air-fuel ratio, and at least another one of the cylinders is designated as a rich combustion cylinder, in which an air-fuel ratio is richer than a stoichiometric air-fuel ratio; operating the adjustment device through a purge control process to control the flow rate of the fluid from the canister to the intake passage; and on condition that the flow rate of the fluid is controlled to a value greater than zero by the purge control process, correcting, through a respective-cylinder correction process, the amount of fuel to be injected from the fuel injection valve by the dither control process for each of the cylinders to compensate for variation in distribution of the fuel vapor that flows into the intake passage from the canister among the cylinders.

Other aspects and advantages of the present disclosure will become apparent from the following description, taken in conjunction with the accompanying drawings, illustrating exemplary embodiments.

### BRIEF DESCRIPTION OF THE DRAWINGS

The disclosure may be understood by reference to the following description together with the accompanying drawings:

FIG. 1 is a diagram of an internal combustion engine and a controller according to one embodiment of the present disclosure;

FIG. 2 is a block diagram showing part of processes executed by the controller;

FIG. 3 is a flowchart showing the procedure of a requirement value outputting process;

FIG. 4 is a flowchart showing the procedure of a target purge ratio setting process;

FIG. 5 is a flowchart showing the procedure of a respective-cylinder correction process;

FIGS. 6A to 6C are diagrams showing a problem to be solved by the embodiment; and

FIG. 7 is a timing diagram showing an advantage of the embodiment.

### DETAILED DESCRIPTION

A controller 40 for an internal combustion engine 10 according to one embodiment will now be described with reference to the drawings.

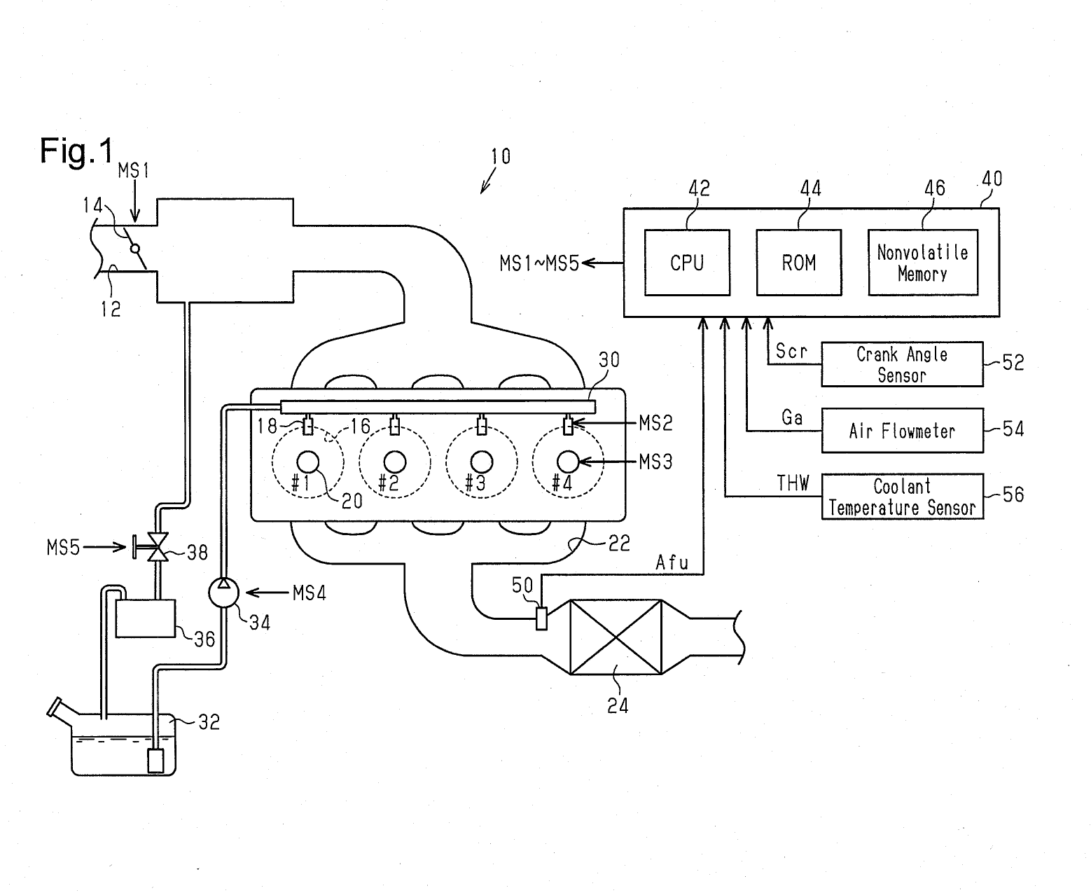

In the internal combustion engine 10 shown in FIG. 1, the air drawn in from an intake passage 12 flows into combustion chambers 16 of the respective cylinders via a throttle valve 14. In each combustion chamber 16, fuel injected from a fuel injection valve 18 is mixed with the air that has flowed in from the intake passage 12. The air-fuel mixture is burned in each combustion chamber 16 by spark discharge of an ignition device 20. The burned air-fuel mixture becomes exhaust gas and is discharged from the combustion chamber 16 into an exhaust passage 22. A three-way catalyst 24 having an oxygen storage capacity is provided in the exhaust passage 22. An air-fuel ratio sensor 50 is provided upstream of the three-way catalyst 24.

The fuel injection valve 18 injects the fuel in a delivery pipe 30. The fuel stored in a fuel tank 32 is pumped up by a fuel pump 34 and supplied to the delivery pipe 30. Some of the fuel is vaporized in the fuel tank 32 to be fuel vapor and is collected by a canister 36. The fuel vapor collected by the canister 36 flows into the intake passage 12 via a purge valve 38, of which the opening degree can be electronically controlled.

The controller 40 controls the internal combustion engine 10. The controller 40 controls the throttle valve 14, the fuel injection valves 18, the ignition devices 20, the fuel pump 34, the purge valve 38, and the like, thereby controlling the controlled amounts such as the torque, the exhaust component, and the like of the engine 10. At this time, the controller 40 refers to an air-fuel ratio Afu detected by the air-fuel ratio sensor 50, an output signal Scr of a crank angle sensor 52, an intake air amount Ga detected by an air flowmeter 54, and a coolant temperature THW of the internal combustion engine 10 detected by a coolant temperature sensor 56. The controller 40 includes a CPU 42, a ROM 44, and a nonvolatile memory 46, which is electrically rewritable. The CPU 42 executes programs stored in the ROM 44 to control, for example, the torque and the exhaust component.

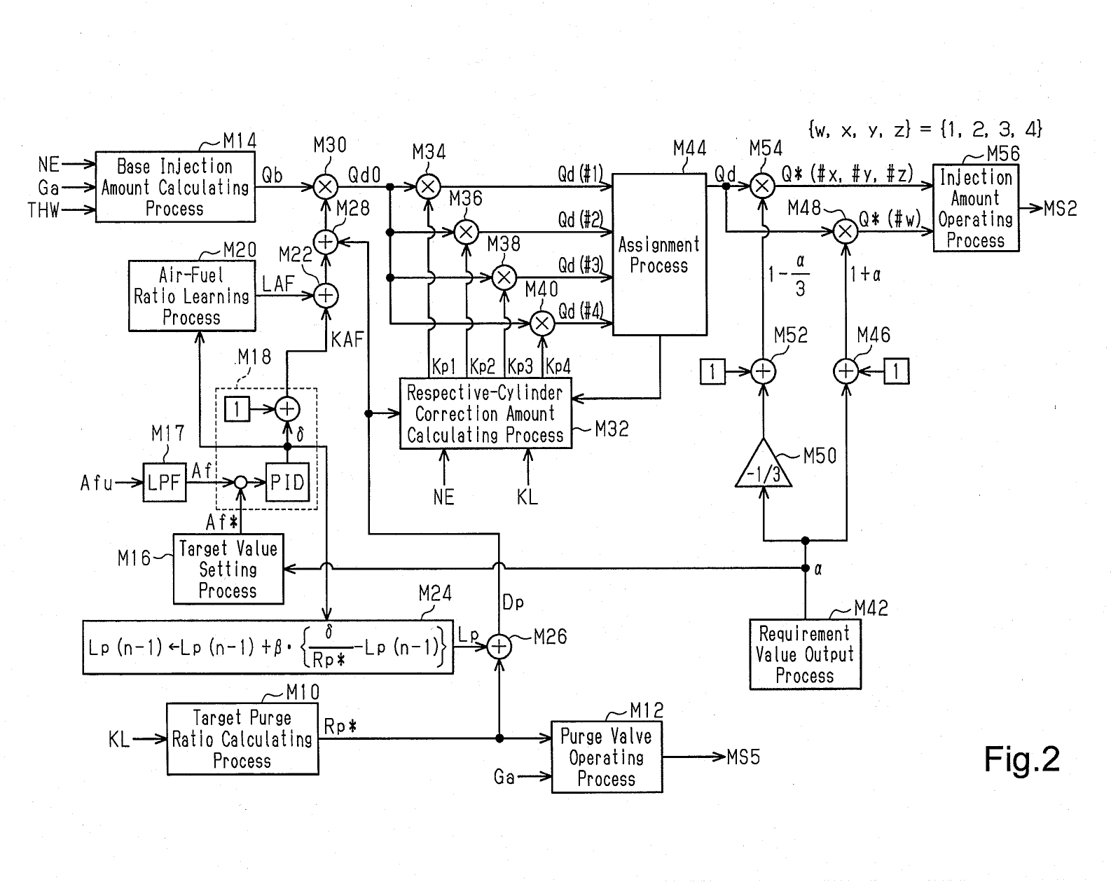

FIG. 2 shows part of the processes that are implemented by the CPU 42 executing programs stored in the ROM 44. A target purge ratio calculating process M10 calculates a target purge ratio Rp* in accordance with a load factor KL. The purge ratio is a value obtained by dividing the flow rate of fluid that flows into the intake passage 12 from the canister 36 by the intake air amount Ga. The target purge ratio Rp* is a target value of the purge ratio for control. The load factor KL is a parameter showing the amount of air that fills the combustion chamber 16. The CPU 42 calculates the load factor KL in accordance with the intake air amount Ga. The load factor KL is the ratio of the inflow air amount per combustion cycle of one cylinder to a reference inflow air amount. The reference inflow air amount is an inflow air amount per combustion cycle of one cylinder when the opening degree of the throttle valve 14 is the maximum. The reference inflow air amount may be variably set in accordance with a rotation speed NE. The CPU 42 calculates the rotation speed NE in accordance with the output signal Scr from the crank angle sensor 52.

A purge valve operating process M12 outputs an operation signal MS5 to the purge valve 38 in accordance with the intake air amount Ga in such a manner that the purge ratio becomes equal to the target purge ratio Rp*. The purge valve operating process M12 also decreases the opening degree of the purge valve 38 as the intake air amount Ga is decreased when the target purge ratio Rp* is the same. The smaller the intake air amount Ga, the higher becomes the pressure in the canister 36 than the pressure in the intake passage 12 and the easier it becomes for the fluid to flow into the intake passage 12 from the canister 36. It is, therefore, necessary to decrease the opening degree of the purge valve 38 as the intake air amount Ga is decreased in order to maintain the target purge ratio Rp* to be constant.

A base injection amount calculating process M14 calculates a base injection amount Qb in accordance with the rotation speed NE and the intake air amount Ga. The base injection amount Qb is an open-loop operation amount for causing the air-fuel ratio of the air-fuel mixture in the combustion chamber 16 to approach the target air-fuel ratio through the open-loop control. The base injection amount calculating process M14 also includes a low-temperature increasing process that increases the base injection amount Qb if the coolant temperature THW is less than or equal to a predetermined temperature Tth as compared with a case in which the coolant temperature THW exceeds the predetermined temperature Tth.

A target value setting process M16 sets a target value Af* of the feedback control amount that is used to control the air-fuel ratio of the air-fuel mixture in the combustion chamber 16 to be the target air-fuel ratio. A low-pass filter M17 performs a low-pass filtering process on the air-fuel ratio Afu detected by the air-fuel ratio sensor 50 and outputs a feedback control amount, which is an air-fuel ratio Af in this embodiment. The air-fuel ratio Af is a parameter showing the time mean value of the air-fuel ratio Afu per combustion cycle.

A feedback process M18 calculates a feedback operation amount KAF, which is an operation amount used to execute feedback control to cause the air-fuel ratio Af to be the target value Af*. The feedback operation amount KAF is a correction coefficient of the base injection amount Qb and is expressed as (1+δ). If a correction factor δ is 0, the correction factor of the base injection amount Qb is zero. If the correction factor δ is greater than 0, the base injection amount Qb is corrected to be increased, and if the correction factor δ is less than 0, the base injection amount Qb is corrected to be decreased. In the present embodiment, the correction factor δ is the sum of the output values of a proportional element that has, as the input, the difference between the target value Af* and the air-fuel ratio Af, an integral element, and a differential element.

An air-fuel ratio learning process M20 sequentially updates an air-fuel ratio learning value LAF in such a manner that the difference between the correction factor δ and 0 is decreased during an air-fuel ratio learning period. The air-fuel ratio learning process M20 includes a process of determining that the air-fuel ratio learning value LAF has converged when the deviation amount between the correction factor δ and 0 is less than or equal to a predetermined value. A coefficient adding process M22 multiplies the feedback operation amount KAF by the air-fuel ratio learning value LAF.

A purge concentration learning process M24 calculates a purge concentration learning value Lp in accordance with the correction factor δ. The purge concentration learning value Lp is obtained by converting the correction factor to a value per 1% of the purge ratio. The correction factor is used to correct the deviation of the base injection amount Qb from the injection amount required to achieve the target air-fuel ratio due to the flow of the fuel vapor from the canister 36 into the intake passage 12. In the present embodiment, the factor that contributes to the deviation of the feedback operation amount KAF from 1 when the target purge ratio Rp* is controlled to a value greater than 0 is assumed to be the fuel vapor that flows into the intake passage 12 from the canister 36. That is, the correction factor δ is assumed to be the correction factor for correcting the deviation of the base injection amount Qb from the injection amount required to achieve the target air-fuel ratio due to the flow of the fuel vapor from the canister 36 into the intake passage 12. More specifically, the purge concentration learning process M24 subtracts a previous purge concentration learning value Lp(n−1) from the correction factor (δ/Rp*) per 1% of the purge ratio and multiplies the difference by the coefficient β. The product is added to the previous purge concentration learning value Lp(n−1), and the sum is substituted for the current purge concentration learning value Lp(n). The coefficient β is a value greater than 0 and less than 1.

A purge correction factor calculating process M26 multiplies the target purge ratio Rp* by the purge concentration learning value Lp to calculate the purge correction factor Dp. A correction coefficient calculating process M28 adds the purge correction factor Dp to the output value of the coefficient adding process M22. A required injection amount calculating process M30 corrects the base injection amount Qb by multiplying the base injection amount Qb by the output value of the correction coefficient calculating process M28 to calculate a required injection amount Qd0.

A respective-cylinder correction amount calculating process M32 calculates respective-cylinder correction amounts Kp1 to Kp4, which are correction amounts for correcting the cylinders #1 to #4 to compensate for the variation among the cylinders in the distribution of the fuel vapor that has flowed into the intake passage 12 from the canister 36.

A respective-cylinder multiplication process M34 calculates a required injection amount Qd (#1) for the cylinder #1 by multiplying the required injection amount Qd0 by the respective-cylinder correction amount Kp1 for the cylinder #1. A respective-cylinder multiplication process M36 calculates a required injection amount Qd (#2) for the cylinder #2 by multiplying the required injection amount Qd0 by the respective-cylinder correction amount Kp2 for the cylinder #2. A respective-cylinder multiplication process M38 calculates a required injection amount Qd (#3) for the cylinder #3 by multiplying the required injection amount Qd0 by the respective-cylinder correction amount Kp3 for the cylinder #3. A respective-cylinder multiplication process M40 calculates a required injection amount Qd (#4) for the cylinder #4 by multiplying the required injection amount Qd0 by the respective-cylinder correction amount Kp4 for the cylinder #4. Hereinafter, the required injection amounts Qd (#1) to Qd (#4) will be collectively referred to as the required injection amount Qd.

If the respective-cylinder correction amounts Kp1 to Kp4 are 1, the required injection amount Qd0 is not corrected. If the respective-cylinder correction amounts Kp1 to Kp4 include a value greater than 1, the respective-cylinder correction amounts Kp1 to Kp4 also include a value less than 1. In other words, if there is any cylinder in which the required injection amount Qd0 is corrected to be increased, there is also a cylinder in which the required injection amount Qd0 is corrected to be decreased.

A requirement value output process M42 is a process in which the correction requirement value α of dither control is calculated and output. The dither control varies the air-fuel ratio of the air-fuel mixture among the cylinders while maintaining the component of the entire exhaust gas discharged from the cylinders #1 to #4 equivalent to that in the case in which the air-fuel ratio of the air-fuel mixture burned in all the cylinders #1 to #4 is equal to the target air-fuel ratio. In the dither control, the air-fuel ratio of the air-fuel mixture in one of the cylinders #1 to #4 is made richer than the stoichiometric air-fuel ratio, and the air-fuel ratio of the air-fuel mixture in the remaining three cylinders is made leaner than the stoichiometric air-fuel ratio. In the dither control, the injection amount in the rich combustion cylinder is calculated by multiplying the required injection amount Qd by a value (1+α). The injection amount in each lean combustion cylinder is calculated by multiplying the required injection amount Qd by a value (1−(α/3)). With the injection amount of the lean combustion cylinders and the rich combustion cylinder set as described above, when the air amount that fills each of the cylinders #1 to #4 is the same, the component of the entire exhaust gas discharged from the cylinders #1 to #4 is maintained to be equivalent to that in the case in which the air-fuel ratio of the air-fuel mixture burned in all the cylinders #1 to #4 is equal to the target air-fuel ratio. With the above configuration, when the air amount that fills each of the cylinders #1 to #4 is the same, the reciprocal of the mean value of the fuel-air ratio of the air-fuel mixture burned in each cylinder is the target air-fuel ratio. The fuel-air ratio is the reciprocal of the air-fuel ratio.

The reciprocal of the mean value of the fuel-air ratio is set as the target air-fuel ratio aiming to control the exhaust component in a desired manner. Hereinafter, when the unburned fuel component in the exhaust gas and the oxygen react sufficiently but not excessively, the exhaust air-fuel ratio is referred to as the stoichiometric air-fuel ratio. When the amount of the unburned fuel component in the exhaust gas that reacts sufficiently and not excessively with the oxygen is referred to as a reference amount, the greater the amount that exceeds the reference amount, the richer the exhaust air-fuel ratio, and the smaller the amount that exceeds the reference amount, the leaner the exhaust air-fuel ratio. For example, the mean value of the exhaust air-fuel ratio per combustion cycle is defined as the exhaust air-fuel ratio with respect to the entire exhaust gas discharged from the cylinders #1 to #4.

An assignment process M44 allocates the required injection amount Qd to each cylinder while designating one of the cylinders #1 to #4 as the rich combustion cylinder and the remaining ones of the cylinders #1 to #4 as the lean combustion cylinders when the dither control is executed. The rich combustion cylinder is desirably changed among the cylinders #1 to #4 at intervals longer than one combustion cycle.

A correction coefficient calculating process M46 adds the correction requirement value α to 1 to calculate the correction coefficient for the required injection amount Qd related to the rich combustion cylinder. A dither correcting process M48 multiplies the required injection amount Qd by the correction coefficient (1+α) to calculate the injection amount command value Q* for the cylinder #w that is designated as a rich combustion cylinder. In this case, w refers to any of 1 to 4.

A multiplication process M50 multiplies the correction requirement value α by −⅓. A correction coefficient calculating process M52 adds the output value of the multiplication process M50 to 1 to calculate the correction coefficient for the required injection amount Qd related to the lean combustion cylinders. A dither correcting process M54 multiplies the required injection amount Qd by the correction coefficient (1−(α/3)) to calculate the injection amount command value Q* for the cylinders #x, #y, and #z, which are designated as lean combustion cylinders. In this case, x, y, z are each any of 1 to 4, and w, x, y, z are all different.

An injection amount operating process M56 generates and outputs an operation signal MS2 for the fuel injection valve 18 of the cylinder #w designated as the rich combustion cylinder in accordance with the injection amount command value Q*(#w) and operates the fuel injection valve 18 to control the amount of fuel injected from the fuel injection valve 18 to be the amount corresponding to the injection amount command value Q*(#w). Additionally, the injection amount operating process M56 generates and outputs an operation signal MS2 for the fuel injection valves 18 of the cylinders #x, #y, and #z designated as the lean combustion cylinders in accordance with the injection amount command values Q*(#x) Q*(#y), and Q*(#z) and operates the fuel injection valves 18 to control the amount of fuel injected from the fuel injection valves 18 to be the amount corresponding to the injection amount command values Q*.

The greater the correction requirement value α when the dither control is executed, the richer becomes the air-fuel ratio Af relative to the mean value of the exhaust air-fuel ratios of all the cylinders #1 to #4. Thus, when the dither control is executed, the target value setting process M16 sets the target value Af* to a value corresponding to a richer air-fuel ratio as compared with a case in which the dither control is not executed.

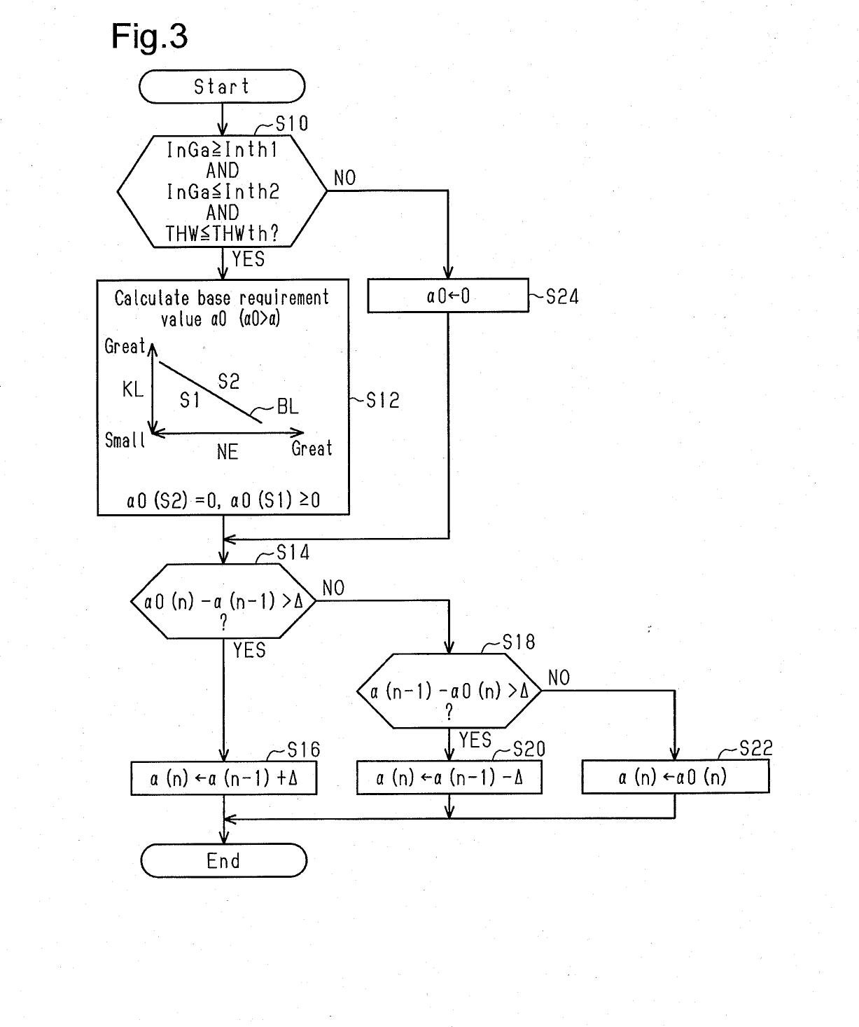

FIG. 3 shows the procedure of the requirement value outputting process M42. The process shown in FIG. 3 is executed by the CPU 42 repeatedly executing programs stored in the ROM 44 at a predetermined interval. In the following description, the number of each step is represented by the letter S followed by a numeral.

In the series of steps shown in FIG. 3, the CPU 42 first determines whether the logical conjunction of the conditions (1) and (2) is true (S10). The condition (1) is that the integrated value InGa of the intake air amount Ga from when the internal combustion engine 10 is started is greater than or equal to a first specified value Inth1. The condition (2) is that the integrated value InGa is less than or equal to a second specified value Inth2 and the coolant temperature THW is less than or equal to a predetermined temperature THWth. This process determines whether a requirement for warm-up of the three-way catalyst 24 is generated. The condition (1) is for determining that the temperature in the upstream end of the three-way catalyst 24 is an operative temperature. The condition (2) is for determining that the entire three-way catalyst 24 has not been operative yet. If the above logical conjunction is true (S10: YES), the CPU 42 determines that there is a requirement for warm-up of the three-way catalyst 24 and calculates the base requirement value α0 of the correction requirement value α (S12).

The CPU 42 sets the base requirement value α0 in accordance with the rotation speed NE and the load factor KL, which define the operating point of the internal combustion engine 10. More specifically, the CPU 42 sets the base requirement value α0 to a value greater than or equal to zero in a first set S1, which is a set of low-load operating points below a boundary line BL, in which the higher the rotation speed NE, the lower the load factor KL becomes. The CPU 42 sets the base requirement value α0 to zero in a second set S2, which is a set of high-load operating points above the boundary line BL. The reason for setting the base requirement value α0 to zero in the second set S2 is that the three-way catalyst 24 is warmed up by the exhaust gas without executing the dither control since the exhaust gas temperature is somewhat high at the operating points of the second set S2. At the operating points of the first set S1, the base requirement value α0 is variably set. For example, if the rotation speed NE is great, the base requirement value α0 may be set to a small value since the exhaust flow rate per unit time is greater than that in a case in which the rotation speed NE is small. If the load factor KL is great, the base requirement value α0 may be set to a small value since the exhaust flow rate per unit time is greater than that in a case in which the load factor KL is small. Alternatively, the CPU 42 may set the base requirement value α0 to zero in a certain region in the first set S1. In this case, at the operating points that cannot be assumed in the normal operation of the internal combustion engine 10, the base requirement value α0 only needs to be set to zero.

More specifically, the ROM 44 stores map data that includes the rotation speed NE and the load factor KL as input variables and the base requirement value α0 as an output variable. The CPU 42 only needs to perform map computation of the base requirement value α0 using the map data. The map data are pair data of discrete values of the input variables and the value of the output variable corresponding to each of the values of the input variables. In the map computation, the value of the output variable of the map data corresponding to any of the values of the input variables of the map data only needs to be provided as the computation result. If the value does not match with any of the values of the input variables of the map data, a value obtained by interpolating the values of the output variables in the map data only needs to be provided as the computation result.

Next, the CPU 42 determines whether a first subtraction value obtained by subtracting a previous correction requirement value α(n−1) from the current base requirement value α(n) is greater than a threshold value Δ (S14). The variable n designates a specific piece of data among the time-series data such as the base requirement value α0. Hereinafter, in the series of steps in FIG. 3, the piece of data calculated in the current control cycle is referred to as n, and the piece of data calculated in the previous control cycle is referred to as (n−1). If the first subtraction value is greater than the threshold value Δ (S14: YES), the CPU 42 adds the threshold value Δ to the previous correction requirement value α(n−1) and substitutes the sum for the current correction requirement value α(n) (S16). In contrast, if the first subtraction value is less than or equal to the threshold value Δ (S14: NO), the CPU 42 determines whether a second subtraction value obtained by subtracting the current base requirement value α(n) from the previous correction requirement value α(n−1) is greater than the threshold value Δ (S18). If the second subtraction value is greater than the threshold value Δ (S18: YES), the CPU 42 subtracts the threshold value Δ from the previous correction requirement value α(n−1) and substitutes the difference for the current correction requirement value α(n) (S20). If the second subtraction value is less than or equal to the threshold value Δ (S18: NO), the CPU 42 substitutes the current base requirement value α0(n) for the current correction requirement value α(n) (S22).

In contrast, in the process of S10, if the outcome of the logical conjunction is negative, the CPU 42 substitutes zero for the base requirement value α0 (S24) and proceeds to the process of S14. When the process of S16, S20, or S22 is completed, the CPU 42 temporarily suspends the series of steps shown in FIG. 3.

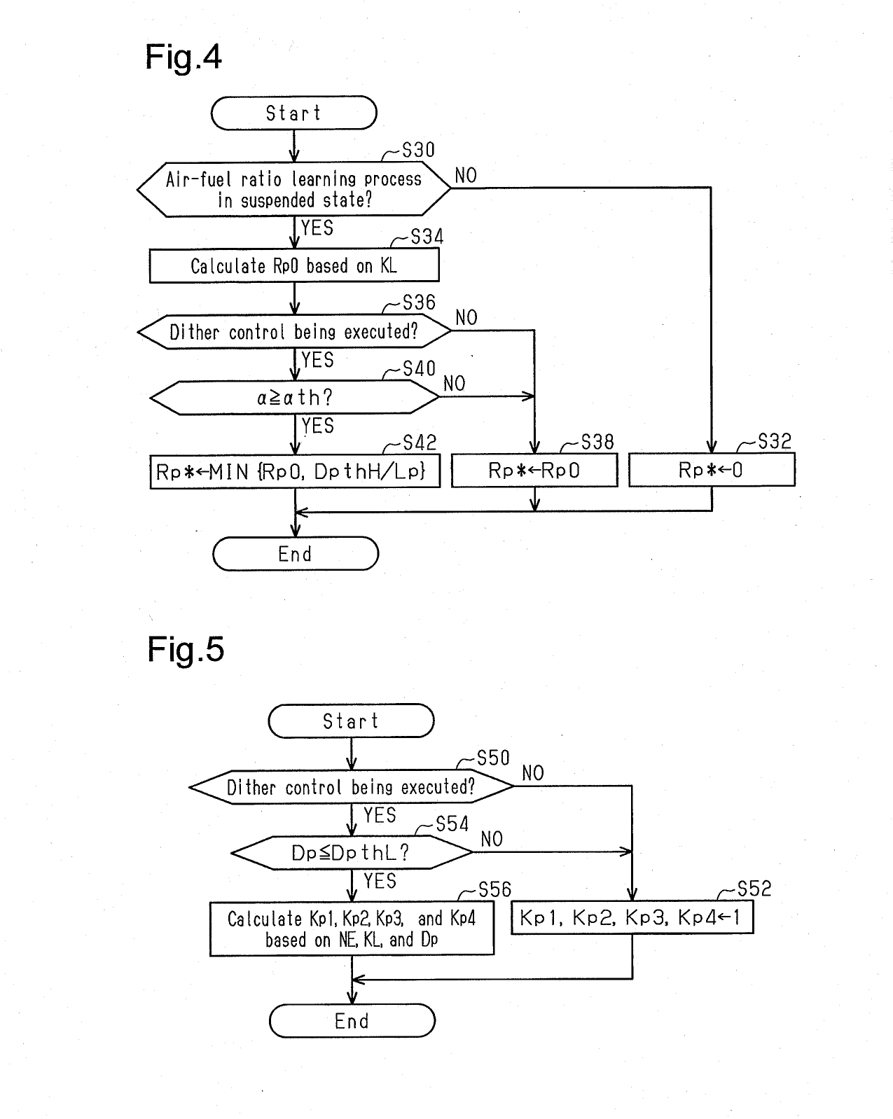

FIG. 4 shows the routine of the target purge ratio calculating process M10. The CPU 42 executes the process shown in FIG. 4 by repeating the programs stored in the ROM 44 at a predetermined interval.

In the series of steps shown in FIG. 4, the CPU 42 first determines whether the air-fuel ratio learning process is in a suspended state (S30). The air-fuel ratio learning process is suspended for a predetermined period from when it is determined that the air-fuel ratio learning value LAF has converged. However, in the present embodiment, the air-fuel ratio learning process may be determined to be in a suspended state although it is not determined that the air-fuel ratio learning value LAF has converged after the internal combustion engine 10 was started. In this case, the required injection amount Qd is calculated using the air-fuel ratio learning value LAF updated before the previous suspension of the internal combustion engine 10 and stored in the nonvolatile memory 46.

If the air-fuel ratio learning process is being executed (S30: NO), the CPU 42 substitutes zero for the target purge ratio Rp* (S32). That is, if the fuel vapor that flows into the intake passage 12 from the canister 36 is not zero, the air-fuel ratio learning value LAF takes a value that is influenced by the fuel vapor. Thus, during execution of the air-fuel ratio learning process, the CPU 42 sets the target purge ratio Rp* to zero in order to block the flow of the fuel vapor into the intake passage 12 from the canister 36.

In contrast, when the air-fuel ratio learning process is in a suspended state (S30: YES), the CPU 42 calculates the required purge ratio Rp0 in accordance with the load factor KL (S34). The CPU 42 inhibits the required injection amount Qd from becoming less than the minimum injection amount of the fuel injection valve 18 by, for example, setting the required purge ratio Rp0 when the load factor KL is small to be smaller than that in the case in which the load factor KL is great. The process is implemented by storing the map data that use the load factor KL as the input variable and the required purge ratio Rp0 as the output variable in the ROM 44 and allowing the CPU 42 to use the map data to perform the map computation of the required purge ratio Rp0.

Next, the CPU 42 determines whether the dither control is being executed (S36). If the dither control is not being executed (S36: NO), the CPU 42 substitutes the required purge ratio Rp0 for the target purge ratio Rp* (S38). In contrast, if the dither control is being executed (S36: YES), the CPU 42 determines whether the correction requirement value α is greater than or equal to a threshold value αth (S40). The threshold value αth is set to a value at which the deterioration of the combustion caused by the dither control is likely to manifest itself due to the distribution variation of the fuel vapor among the cylinders if the target purge ratio Rp* is set in the process of S38. If the correction requirement value α is less than the threshold value αth (S40: NO), the CPU 42 proceeds to the process of S38.

In contrast, if the correction requirement value α is greater than or equal to the threshold value α (S40: YES), the CPU 42 substitutes the smaller one of a value obtained by dividing a purge correction upper limit value DpthH by the purge concentration learning value Lp and the required purge ratio Rp0 for the target purge ratio Rp* (S42). The purge correction upper limit value DpthH is a value that limits the upper limit value of the absolute value of the purge correction factor Dp and takes a negative value. Since the purge concentration learning value Lp is also a negative value, DpthH/Lp is greater than or equal to zero. The process of S42 prevents the value obtained by dividing the flow rate of the fuel vapor that flows into the intake passage 12 from the canister 36 by the intake air amount Ga from being excessively great. When the process of S32, S38, or S42 is completed, the CPU 42 temporarily suspends the series of steps shown in FIG. 4.

FIG. 5 shows the procedure of the respective-cylinder correction amount calculating process M32. The process shown in FIG. 5 is executed by the CPU 42 repeatedly executing programs stored in the ROM 44 at a predetermined interval.

In the series of steps shown in FIG. 5, the CPU 42 first determines whether the dither control is being executed (S50). If the dither control is not being executed (S50: NO), the CPU 42 substitutes 1 for each of the respective-cylinder correction amounts Kp1, Kp2, Kp3, and Kp4 (S52). That is, if the dither control is not being executed, the required injection amount Qd0 is not corrected by the respective-cylinder correction amounts Kp1, Kp2, Kp3, and Kp4.

In contrast, if the dither control is being executed (S50: YES), the CPU 42 determines whether the purge correction factor Dp is less than or equal to a specified factor DpthL, the absolute value of which is smaller than the purge correction upper limit value DpthH used in the process of S42 (S54). The specified factor DpthL is set to the upper limit value at which the influence of the distribution variation of the fuel vapor that flows into the intake passage 12 from the canister 36 among the cylinders becomes significant, in other words, the lower limit value of the absolute value. If the purge correction factor Dp is greater than the specified factor DpthL (S54: NO), the CPU 42 proceeds to the process of S52. In contrast, if the purge correction factor Dp is less than or equal to the specified factor DpthL (S54: YES), the CPU 42 variably sets each of the respective-cylinder correction amounts Kp1, Kp2, Kp3, and Kp4 in accordance with the rotation speed NE, the load factor KL, and the purge correction factor Dp (S56). The rotation speed NE and the load factor KL are parameters that cause fluctuation of the distribution variation of the fuel vapor to the intake passage 12 from the canister 36 among the cylinders. More specifically, the ROM 44 stores the map data including the rotation speed NE, the load factor KL, and the purge correction factor Dp as the input variables and the respective-cylinder correction amount Kp1 as the output variable. The CPU 42 only needs to perform the map computation of the respective-cylinder correction amount Kp1 using the map data. Similarly, the map data for each of the respective-cylinder correction amounts Kp2, Kp3, and Kp4 may also be stored in the ROM 44, and the CPU 42 only needs to perform the map computation of each respective-cylinder correction amount using the corresponding map data. If the process of S52 or S56 is completed, the CPU 42 temporarily suspends the process shown in FIG. 5.

The operation of the present embodiment will now be described.

At the operating points at which the temperature of the three-way catalyst 24 is low and the exhaust gas temperature is not increased much after the internal combustion engine 10 is started, the CPU 42 executes the dither control by setting the correction requirement value α to a value greater than zero to warm up the three-way catalyst 24. Furthermore, even if it is not determined that the air-fuel ratio learning value LAF has converged after the internal combustion engine 10 was started, the CPU 42 controls the purge ratio to a value greater than zero in such a manner that the amount of fuel vapor in the canister 36 is not excessively increased. If the purge ratio becomes greater than zero, the fuel vapor that has flowed into the intake passage 12 from the canister 36 is not distributed evenly among the cylinders. The variation at this time is caused due to, for example, the structure of the internal combustion engine 10.

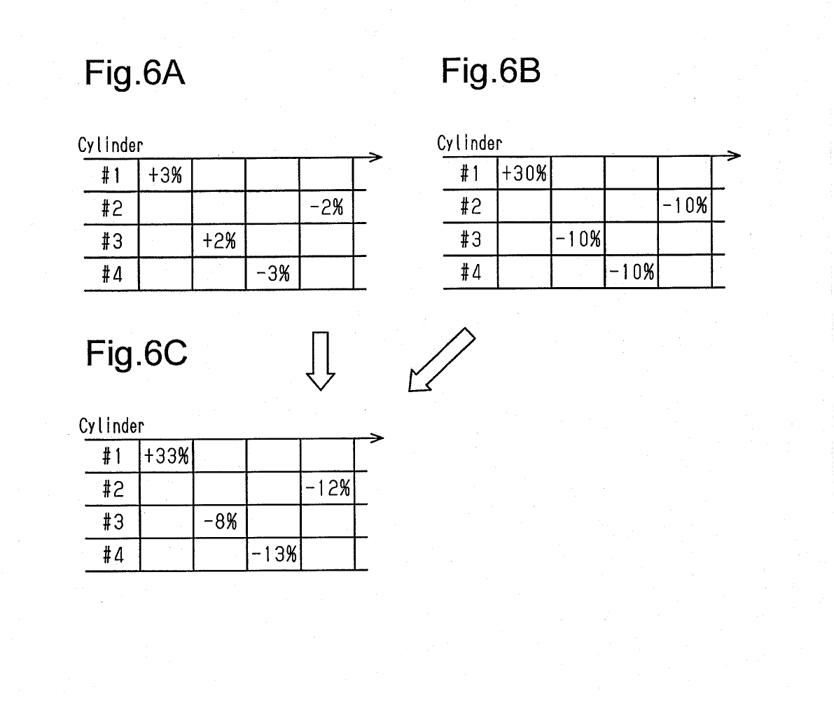

FIG. 6A shows the percentage of the fuel vapor that flows into the cylinders #1 to #4 in relation to the required injection amount Qd0 for each of the cylinders #1 to #4. FIG. 6B shows a correction rate of the required injection amount Qd0 by the dither control for the cylinders #1 to #4 when the correction requirement value α is 0.3 with the cylinder #1 designated as the rich combustion cylinder. FIG. 6C shows the sum of the percentage of the fuel vapor in relation to the required injection amount Qd0 shown in FIG. 6A and the percentage of the correction amount by the dither control in relation to the required injection amount Qd0 shown in FIG. 6B. As shown in FIG. 6C, if the dither control is executed when the fuel vapor flows into the intake passage 12 from the canister 36, the deviation of the injection amount in the cylinders #1 to #4 from the required injection amount Qd0 may be greater than that when only the dither control is executed. Thus, the air-fuel ratio of the rich combustion cylinder may possibly become richer than it is assumed, which causes the combustion to deteriorate, or the air-fuel ratio of the lean combustion cylinders may possibly become leaner than it is assumed, which causes the combustion to deteriorate.

The internal combustion engine 10 of the present embodiment is designed in such a manner that the distribution variation of the fuel vapor among the cylinders is reduced. This sufficiently limits the influence on the combustion due to the variation of the fuel vapor among the cylinders as long as the dither control is not executed. However, when the dither control is executed, the tendency of the combustion to deteriorate by making the air-fuel ratio lean or rich is increased due to the distribution variation of the fuel vapor among the cylinders by the purge control. Additionally, since the internal combustion engine 10 is cold during the warm-up process of the three-way catalyst 24, the volatility of the fuel is lower than that in a case in which the internal combustion engine 10 is warm, and the injection amount is not reliably controlled. In the present embodiment, feedforward control is performed that compensates for the amount of fuel that is not burned by increasing the base injection amount Qb when the coolant temperature THW is low as compared with a case in which the coolant temperature THW is high. However, the injection amount is not reliably controlled due to control errors at that time. Furthermore, in the present embodiment, even if it is before the air-fuel ratio learning value LAF is determined to have converged after the current startup of the internal combustion engine 10, the target purge ratio Rp* may become greater than zero, and the dither control may be executed in such a case. Thus, the accuracy of the air-fuel ratio learning value LAF may possibly be reduced for the warm-up of the three-way catalyst 24, and the injection amount is not reliably controlled. For this reason, although the tendency for the combustion to deteriorate due to the dither control does not manifest itself significantly with only the variation in the fuel vapor among the cylinders, but may possibly manifest itself due to both the variation in the fuel vapor among the cylinders and the low reliability in controlling the injection amount.

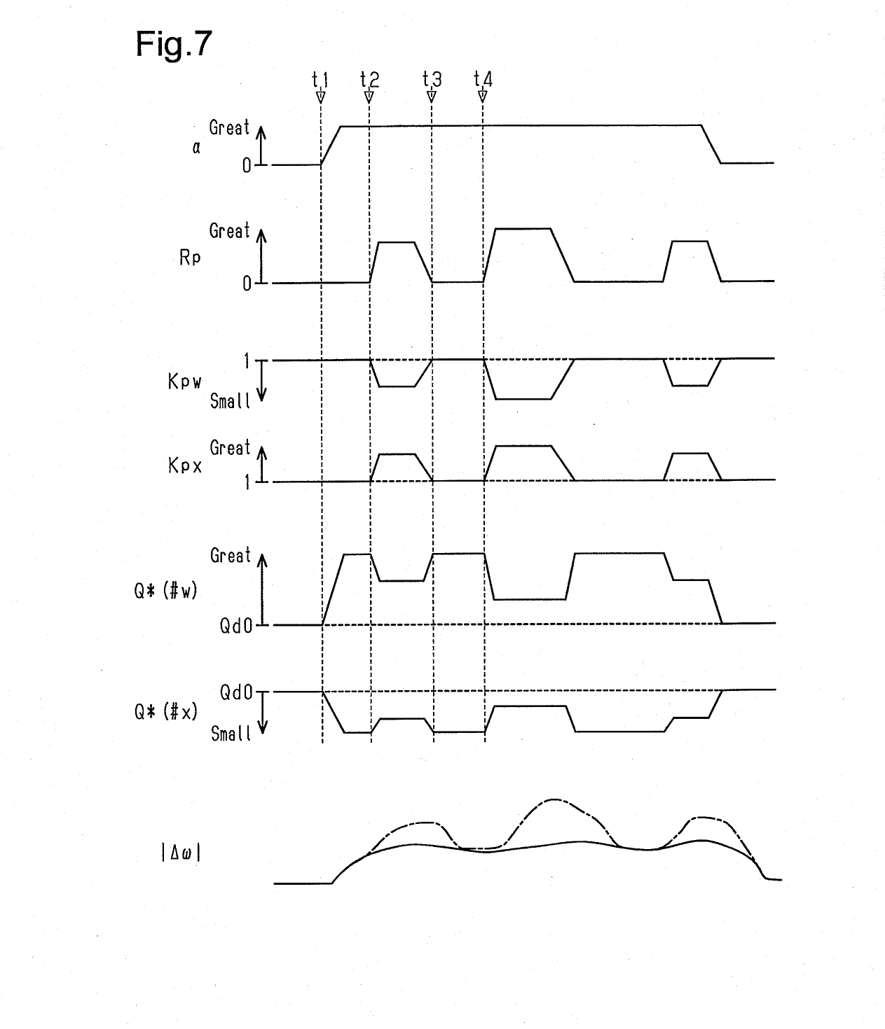

FIG. 7 shows changes in the correction requirement value α, the purge ratio Rp, the respective-cylinder correction amount Kpw of the rich combustion cylinder (#w), the respective-cylinder correction amount Kpx of the lean combustion cylinder (#x), the injection amount command value Q*(#w) of the rich combustion cylinder (#w), the injection amount command value Q*(#x) of the lean combustion cylinder (#x), and the absolute value of a rotation fluctuation amount Δω. In the present embodiment, the rotation fluctuation amount Δω is a parameter that quantifies the degree of deterioration of the combustion. That is, in terms of the rotation speed (instantaneous rotation speed ω) at a predetermined angular interval including the compression top dead center only once, the rotation fluctuation amount Δω is a value obtained by subtracting the rotation speed of one of the pair of cylinders in which the compression top dead center appears later from the rotation speed of the other cylinder in which the compression top dead center appears in advance among the pair of cylinders in which the compression top dead center appears one after the other. If the combustion deteriorates so that the torque is decreased, the rotation fluctuation amount Δω takes a negative value, and the absolute value is great.

As shown in FIG. 7, if the correction requirement value α is increased from zero from a point in time t1 to start the dither control, the absolute value of the rotation fluctuation amount Δω is increased. This is because the torque generated in the lean combustion cylinder is smaller than the torque generated in the rich combustion cylinder. Subsequently, during a period from a point in time t2 to a point in time t3, the purge ratio Rp becomes greater than zero. In this case, the required injection amount Qd0 of each of the cylinders #1 to #4 is corrected using the corresponding respective-cylinder correction amount Kp1, Kp2, Kp3, or Kp4. Thus, the injection amount command value Q* reflects the respective-cylinder correction amount Kp1, Kp2, Kp3, or Kp4. This reduces the influence of the distribution variation of the fuel vapor that has flowed into the intake passage 12 from the canister 36 among the cylinders on the air-fuel ratio of the cylinders. Thus, the tendency for the combustion to deteriorate by the dither control is inhibited from being promoted by the distribution variation of the fuel vapor among the cylinders, and that tendency is prevented from manifesting itself.

The long dashed short dashed line in FIG. 7 shows the absolute value of the rotation fluctuation amount & when the correction using the respective-cylinder correction amounts Kp1, Kp2, Kp3, and Kp4 is not performed.

The above described embodiment has the following advantages.

(1) The respective-cylinder correction amounts Kp1, Kp2, Kp3, and Kp4 are variably set in accordance with the rotation speed NE and the load factor KL. This configuration addresses the fluctuation of the variation in the distribution ratio of the fuel vapor that has flowed into the intake passage 12 from the canister 36 among the cylinders in accordance with the rotation speed NE and the load factor KL.

(2) If the operating point of the internal combustion engine 10 is included in the second set S2, the correction using the respective-cylinder correction amounts Kp1, Kp2, Kp3, and Kp4 is not executed. Thus, the respective-cylinder correction amounts Kp1, Kp2, Kp3, and Kp4 do not need to be applied in the second set S2. This reduces the number of times of the application.

(3) If the absolute value of the purge correction factor Dp is small, the signal-to-noise ratio (SNR) is decreased. Thus, the accuracy in controlling to compensate for the distribution variation of the fuel vapor using the respective-cylinder correction amounts Kp1, Kp2, Kp3, and Kp4 may be decreased. To solve this problem, the correction using the respective-cylinder correction amounts Kp1, Kp2, Kp3, and Kp4 is executed on condition that the purge correction factor Dp is less than or equal to the specified factor DpthL. This improves the accuracy in controlling to compensate for the distribution variation of the fuel vapor.

(4) The deterioration of the combustion by the dither control is promoted by the distribution variation of the fuel vapor among the cylinders caused by the purge control and manifests itself. In this regard, the target purge ratio Rp* is limited when the correction requirement value α is greater than or equal to the threshold value αth. This suppresses the above-described deterioration of the combustion.

The correspondence between the items in the above embodiments and the items described in the above SUMMARY is as follows.

In Example 1, the exhaust purification device corresponds to the three-way catalyst 24, and the adjustment device corresponds to the purge valve 38. The dither control process corresponds to the correction coefficient calculating process M46, the dither correction process M48, the multiplication process M50, the correction coefficient calculating process M52, the dither correction process M54, the injection amount operating process M56, and the processes of S14 to S22 when the correction requirement value α is greater than zero. The purge control process corresponds to the purge valve operating process M12. The respective-cylinder correction process corresponds to the respective-cylinder correction amount calculating process M32 and the variation correction processes M34 to M40. In Example 3, the reduction correction amount calculating process corresponds to the purge correction factor calculating process M26. The required injection amount setting process corresponds to the target value setting process M16, the feedback process M18, the coefficient adding process M22, the correction coefficient calculating process M28, and the required injection amount calculating process M30. Example 4 corresponds to the process of S10 in which the requirements for the dither control in the above-described embodiment are specified. Example 5 corresponds to the processes of S12 and S50. Example 6 corresponds to the process of S54. The “specified amount” corresponds to the absolute value of (Qb·DpthL). In Example 7, the limiting process corresponds to the processes of S38 to S42.

The above-described embodiment may be modified as follows.

As the required injection amount Qd, the base injection amount Qb is not limited to a value corrected using the feedback operation amount KAF, the air-fuel ratio learning value LAF, and the purge correction factor Dp. For example, the base injection amount Qb may be a value that is corrected using two parameters among the feedback operation amount KAF, the air-fuel ratio learning value LAF, and the purge correction factor Dp, such as a value that is corrected using the feedback operation amount KAF and the air-fuel ratio learning value LAF but not corrected using the purge correction factor Dp. Alternatively, the base injection amount Qb may be a value that is corrected using one parameter among the feedback operation amount KAF, the air-fuel ratio learning value LAF, and the purge correction factor Dp, such as a value corrected using the air-fuel ratio learning value LAF but not corrected using the feedback operation amount KAF and the purge correction factor Dp.

In the above-described embodiment, the respective-cylinder correction amounts Kp1, Kp2, Kp3, and Kp4 are used as the correction coefficient of the required injection amount Qd0, but the configuration is not limited to this. For example, the respective-cylinder correction amount may be a correction amount to be added to the injection amount (Qd0·(1+α)) of the rich combustion cylinder or the injection amount (Qd·(1−α/3)) of the lean combustion cylinder. The respective-cylinder correction amount may be a correction coefficient for correcting the purge correction factor Dp.

The respective-cylinder correction amounts Kp1, Kp2, Kp3, and Kp4 do not necessarily have to be variably set in accordance with the rotation speed NE and the load. The respective-cylinder correction amounts may be variably set in accordance with only the load, may be variably set in accordance with only the rotation speed NE, or may be a fixed value.

In the above-described embodiment, the respective-cylinder correction process is executed when the dither control is executed in response to the requirement for warm-up, but the configuration is not limited to this. For example, if the operating point of the internal combustion engine 10 is located in the first set S1, the respective-cylinder correction process may be executed although the dither control is not executed. Furthermore, in any operating points of the internal combustion engine 10, the respective-cylinder correction process may be constantly executed if the target purge ratio Rp* is greater than zero.

Furthermore, one of the respective-cylinder correction amounts Kp1, Kp2, Kp3, and Kp4 corresponding to the rich combustion cylinder may be calculated in accordance with the correction coefficient (1+α), or the one corresponding to the lean combustion cylinder may be calculated in accordance with the correction coefficient (1−α/3). That is, the required injection amount Qd(#1) of the cylinder #1 is Qd0·Kp1, and when the cylinder #1 is designated as the rich combustion cylinder, the injection amount command value Q*(#1) is (Qd0·Kp1·(1+α)). Thus, the correction using the respective-cylinder correction amount Kp1 is influenced by the correction coefficient (1+α). As described above, if the correction coefficient is ignored, the respective-cylinder correction amounts Kp1, Kp2, Kp3, and Kp4 may possibly be inappropriate correction amounts. Of course, if the correction requirement value α is calculated in accordance with the rotation speed NE and the load factor KL, the respective-cylinder correction amounts Kp1, Kp2, Kp3, and Kp4 may be calculated in accordance with whether the cylinder is designated as the lean combustion cylinder or the rich combustion cylinder in addition to the rotation speed NE and load factor KL. In this case also, the value of the correction coefficient is grasped from the information including the rotation speed NE, the load factor KL, and whether the cylinder is designated as the lean combustion cylinder or the rich combustion cylinder. Thus, the respective-cylinder correction amounts Kp1, Kp2, Kp3, and Kp4 are set to the correction amounts corresponding to the correction coefficient.

In the above-described embodiment, if the correction requirement value α is greater than or equal to the predetermined value αth, the target purge ratio Rp* is limited to be smaller. If the absolute value of the purge concentration learning value Lp is great, the degree of limiting of the target purge ratio Rp* is set to be greater than that in a case in which the absolute value of the purge concentration learning value Lp is small, but the configuration is not limited to this. For example, the target purge ratio Rp* may be limited to a value that is less than or equal to a fixed value regardless of the purge concentration learning value Lp.

In the above-described embodiment, the requirements for the dither control process may include the state of the air-fuel ratio sensor 50. That is, the fact that the air-fuel ratio sensor 50 is activated and the air-fuel ratio feedback control is to be started may be the requirement for the dither control. In this case, as compared with a case in which the dither control is executed before the air-fuel ratio sensor 50 is activated, the injection amount is more reliably controlled. The requirement for the dither control may include the determination that the air-fuel ratio feedback control has been started so that the air-fuel ratio learning value LAF has been updated and converged. In this case also, if the controllability of the injection amount is reduced because the engine is cold, it is particularly effective to perform the respective-cylinder correction process in a case in which the target purge ratio Rp* is greater than zero.

For example, when the dither control is executed in response to the execution requirement of a sulfur release process, the required injection amount Qd corrected using the respective-cylinder correction amounts Kp1, Kp2, Kp3, and Kp4 may be used. This inhibits the deterioration of the combustion caused by the dither control from being promoted by the purge control. Furthermore, if the dither control is executed, the feed forward correction of the target value Δf* compensates for the deviation of the air-fuel ratio Af from the mean value of the actual exhaust air-fuel ratios. However, the error of the feedforward correction becomes a factor in reducing the controllability of the injection amount. Thus, since the combustion is likely to deteriorate during execution of the dither control, it is effective to use the required injection amount Qd corrected by the respective-cylinder correction amounts Kp1, Kp2, Kp3, and Kp4. Of course, when the dither control in response to the requirement for warm-up of the three-way catalyst 24 and other dither controls are executed, the required injection amount Qd corrected by the respective-cylinder correction amount Kp1, Kp2, Kp3, and Kp4 may be used in only the dither control executed in response to the requirement for warm-up.

The correction requirement value α may be variably set in accordance with the coolant temperature THW in addition to the rotation speed NE and the load factor KL. Further, for example, the correction requirement value α may be variably set based only on two parameters, which are either the rotation speed NE and coolant temperature THW or the load factor KL and coolant temperature THW. Also, the correction requirement value α may be variably set based on only one of the three parameters. Although the rotation speed NE and the load factor KL are used as parameters for determining the operating point of the internal combustion engine 10, the load factor KL may be replaced by the accelerator operation amount. Alternatively, the correction requirement value α may be variably set in accordance with the intake air amount Ga instead of the rotation speed NE and the load.

It is not essential to vary the correction requirement value α based on the above parameters.

In the above-described embodiment, the number of the lean combustion cylinders is greater than the number of the rich combustion cylinders, but the configuration is not limited to this. The number of the rich combustion cylinders and the number of the lean combustion cylinders may be equal to each other. Alternatively, instead of setting each of the cylinders #1 to #4 to either a lean combustion cylinder or a rich combustion cylinder, the air-fuel ratio of one cylinder may be set to the target air-fuel ratio, for example. Furthermore, if the cylinder filling air amount remains constant in one combustion cycle, the reciprocal of the mean value of the fuel-air ratios does not need to be the target air-fuel ratio. For example, in the case of four cylinders as in the above-described embodiment, if the cylinder filling air amount remains constant, the reciprocal of the mean value of the fuel-air ratios at five strokes may be used as the target air-fuel ratio. Also, the reciprocal of the mean value of the fuel-air ratios at three strokes may be used as the target air-fuel ratio. However, it is desirable that a period in which both a rich combustion cylinder and a lean combustion cylinder exist in a single combustion cycle occur at least once every two combustion cycles. In other words, if the cylinder filling air amount remains constant for a predetermined period, it is desirable to set the predetermined period to two or fewer combustion cycles when setting target air-fuel ratio to the reciprocal of the mean value of the fuel-air ratios. For example, if the predetermined period is set to two combustion cycles and the rich combustion cylinder exists only once during two combustion cycles, the appearance order of the rich combustion cylinder and the lean combustion cylinder is represented by R, L, L, L, L, L, L, L, where the rich combustion cylinder is represented by R, and the lean combustion cylinder is represented by L. In this case, a period of one combustion cycle that is shorter than the predetermined period and represented by R, L, L, L is provided, and part of cylinders #1 to #4 is a lean combustion cylinder and the other cylinders are rich combustion cylinders. When the reciprocal of the mean value of the fuel-air ratios of periods different from one combustion cycle is used as the target air-fuel ratio, it is desirable that the amount of air that is drawn into the internal combustion engine in the intake stroke and is blown back to the intake passage before the intake valve closes be negligible. The low-pass filter M17 desirably outputs the time mean value of the air-fuel ratio Afu per the predetermined period.

In the above-described embodiment, the purge valve 38 is operated to control the purge ratio, but the configuration is not limited to this. For example, if the adjustment device includes a pump, the purge ratio may be controlled by manipulating the power consumption of the pump.

In the above-described embodiment, the purge valve 38 exemplifies the adjustment device that adjusts the inflow amount of the fuel vapor collected in the canister 36 into the intake passage 12, but the configuration is not limited to this. For example, in an internal combustion engine 10 having a forced-induction device, the pressure in the intake passage 12 may not be lower than the pressure in the canister 36. Taking this into consideration, the adjustment device may be provided with a pump that draws in the fluid in the canister 36 and discharges the fluid to the intake passage 12 in addition to the purge valve 38.

A temperature increase requirement may be a requirement for increasing the temperature when the execution requirement for the sulfur release process is generated. The temperature increase requirement by the sulfur release process only needs to be generated when the sulfur poisoning amount of the three-way catalyst 24 is greater than or equal to a predetermined value. The sulfur poisoning amount only needs to be calculated by calculating the increase amount of the sulfur poisoning amount to have a greater value as the rotation speed NE and the load factor KL increase and by integrating the increase amount. However, when the dither control is executed, the increase amount of the sulfur poisoning amount is reduced as compared with the case in which the dither control is not executed. The temperature increase requirement may be generated in the operating region in which sulfur is easily deposited in the three-way catalyst 24 (such as during idling).

If a gasoline particulate filter (GPF) is provided downstream of the three-way catalyst 24, the temperature increase requirement may be a temperature increase requirement of the GPF. Alternatively, the temperature increase requirement may be a requirement for increasing the temperature of the exhaust gas through the dither control to increase the temperature in the exhaust passage 22 so that condensate does not adhere to the exhaust passage 22.

As the exhaust purifying device, the GPF may be provided downstream of the three-way catalyst 24, or the three-way catalyst 24 may be provided downstream of the GPF. The GPF may be provided as the only exhaust purifying device. However, if a catalyst that has the oxygen storage capacity is not provided upstream of the GPF, the GPF is desirably provided with the oxygen storage capacity to improve the ability to increase the temperature by the dither control.

The controller is not limited to a device that includes the CPU 42 and the ROM 44 and executes software processing. For example, at least part of the processes executed by the software in the above-illustrated embodiment may be executed by hardware circuits dedicated to executing these processes (such as ASIC). That is, the controller may be modified as long as it has any one of the following configurations (a) to (c). (a) A configuration including a processor that executes all of the above-described processes according to programs and a program storage device such as a ROM that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. A plurality of software processing circuits each including processor and a program storage device and a plurality of dedicated hardware circuits may be provided. That is, the above processes may be executed in any manner as long as the processes are executed by processing circuitry that includes at least one of a set of one or more software processing circuits and a set of one or more dedicated hardware circuits.

The internal combustion engine is not limited to a four-cylinder engine. For example, an in-line six-cylinder engine may be used. Alternatively, a V engine may be used, which includes a first exhaust purification device and a second exhaust purification device that purify exhaust gas from different cylinders. Also, an internal combustion engine equipped with a forced-induction device may be used. In the case of the internal combustion engine including the forced-induction device, heat in the exhaust gas is taken away by the forced induction device. Thus, the temperature of the exhaust purifying device, which is located downstream of the forced-induction device, is unlikely to be increased. It is, therefore, particularly effective to use the dither control.

The internal combustion engine may include a fuel injection valve that injects fuel into the intake passage 12 instead of the fuel injection valves 18, which inject fuel into the combustion chambers 16.

1. A controller for an internal combustion engine, wherein
the internal combustion engine includes
an exhaust purifying device, which purifies exhaust gas discharged from a plurality of cylinders,
fuel injection valves provided for the respective cylinders,
a canister, which collects fuel vapor in a fuel tank, which stores fuel to be injected by the fuel injection valves, and
an adjustment device, which adjusts a flow rate of fluid from the canister to an intake passage, and
the controller is configured to execute
a dither control process of operating the fuel injection valves in such a manner that at least one of the cylinders is designated as a lean combustion cylinder, in which an air-fuel ratio is leaner than a stoichiometric air-fuel ratio, and at least another one of the cylinders is designated as a rich combustion cylinder, in which an air-fuel ratio is richer than a stoichiometric air-fuel ratio,
a purge control process of operating the adjustment device in such a manner to control the flow rate of the fluid from the canister to the intake passage, and
a respective-cylinder correction process of correcting, on condition that the flow rate of the fluid is controlled to a value greater than zero by the purge control process, the amount of fuel to be injected from the fuel injection valve by the dither control process for each of the cylinders to compensate for variation in distribution of the fuel vapor that flows into the intake passage from the canister among the cylinders.

2. The controller for an internal combustion engine according to claim 1, wherein the respective-cylinder correction process is a process of calculating a correction amount of each of the cylinders in accordance with a rotation speed and a load of a crankshaft of the internal combustion engine.

3. The controller for an internal combustion engine according to claim 1, wherein
the controller is configured to execute
a base injection amount calculating process of calculating a base injection amount in accordance with an air amount filling a combustion chamber of the internal combustion engine,
a reduction correction amount calculating process of calculating a reduction correction amount for correcting the base injection amount to be reduced in accordance with the flow rate of the fluid, and
a required injection amount calculating process of calculating a required injection amount in accordance with the process of correcting the base injection amount to be reduced using the reduction correction amount,
the dither control process is a process of determining the injection amount of the fuel injection valve that injects fuel to the lean combustion cylinder by correcting the required injection amount to be reduced and determining the injection amount of the fuel injection valve that injects fuel to the rich combustion cylinder by correcting the required injection amount to be increased, and
the respective-cylinder correction process is a process of correcting the required injection amount used by the dither control process for each of the cylinders and calculating the correction amount for each of the cylinders in accordance with the reduction correction amount.

4. The controller for an internal combustion engine according to claim 1, wherein the respective-cylinder correction process corrects the amount of fuel to be injected from the fuel injection valve by the dither control process executed in response to a warm-up requirement for warming up the exhaust purifying device.

5. The controller for an internal combustion engine according to claim 4, wherein the dither control process executed in response to the warm-up requirement is executed when an actual operating point is in a first set of operating points determined in accordance with the rotation speed and the load of the crankshaft of the internal combustion engine and is not executed when the actual operating point is in a second set, which does not include the operating points of the first set, and
the respective-cylinder correction process is not executed when the actual operating point is in the second set.

6. The controller for an internal combustion engine according to claim 1, wherein the respective-cylinder correction process is executed on condition that the amount of the fuel vapor that flows into the intake passage from the canister by the purge control process is greater than or equal to a specified amount.

7. The controller for an internal combustion engine according to claim 1, wherein the controller is configured to execute, if an absolute value of a difference between the air-fuel ratio of the lean combustion cylinder and the air-fuel ratio of the rich combustion cylinder caused by the dither control process is greater than or equal to a predetermined value, a limiting process of limiting the flow rate of the fluid by the purge control process to be smaller than that in a case in which the absolute value is less than the predetermined value.

8. A controller for an internal combustion engine, wherein
the internal combustion engine includes
an exhaust purifying device, which purifies exhaust gas discharged from a plurality of cylinders,
fuel injection valves provided for the respective the cylinders,
a canister, which collects fuel vapor in a fuel tank, which stores fuel to be injected by the fuel injection valves, and
an adjustment device, which adjusts a flow rate of fluid from the canister to an intake passage,
the controller comprises circuitry configured to execute,
a dither control process of operating the fuel injection valves in such a manner that at least one of the cylinders is designated as a lean combustion cylinder, in which an air-fuel ratio is leaner than a stoichiometric air-fuel ratio, and at least another one of the cylinders is designated as a rich combustion cylinder, in which an air-fuel ratio is richer than a stoichiometric air-fuel ratio,
a purge control process of operating the adjustment device in such a manner to control the flow rate of the fluid from the canister to the intake passage, and
a respective-cylinder correction process of correcting, on condition that the flow rate of the fluid is controlled to a value greater than zero by the purge control process, the amount of fuel to be injected from the fuel injection valve by the dither control process for each of the cylinders to compensate for variation in distribution of the fuel vapor that flows into the intake passage from the canister among the cylinders.

9. A method for controlling an internal combustion engine, wherein
the internal combustion engine includes
an exhaust purifying device, which purifies exhaust gas discharged from a plurality of cylinders,
fuel injection valves provided for the respective cylinders,
a canister, which collects fuel vapor in a fuel tank, which stores fuel to be injected by the fuel injection valves, and
an adjustment device, which adjusts a flow rate of fluid from the canister to an intake passage, and
the control method comprise:
operating the fuel injection valves through a dither control process in such a manner that at least one of the cylinders is designated as a lean combustion cylinder, in which an air-fuel ratio is leaner than a stoichiometric air-fuel ratio, and at least another one of the cylinders is designated as a rich combustion cylinder, in which an air-fuel ratio is richer than a stoichiometric air-fuel ratio;
operating the adjustment device through a purge control process to control the flow rate of the fluid from the canister to the intake passage; and
on condition that the flow rate of the fluid is controlled to a value greater than zero by the purge control process, correcting, through a respective-cylinder correction process, the amount of fuel to be injected from the fuel injection valve by the dither control process for each of the cylinders to compensate for variation in distribution of the fuel vapor that flows into the intake passage from the canister among the cylinders.
